(19) United States
(12) Patent Application Publication
(10) Pub. No.: US 2017/0068777 A1
(43) Pub. Date: Mar. 9, 2017

(54) METHODS OF IDENTIFYING AND FORMULATING FOOD COMPOUNDS THAT MODULATE PHENOTYPE-RELATED TARGETS

(71) Applicant: Tufts University, Medford, MA (US)

(72) Inventors: Laurence D. Parnell, Cambridge, MA (US); Martin S. Obin, Boston, MA (US); Kenneth E. Westerman, Somerville, MA (US)

(21) Appl. No.: 15/255,732

(22) Filed: Sep. 2, 2016

Related U.S. Application Data
(60) Provisional application No. 62/214,510, filed on Sep. 4, 2015.

(51) Int. Cl. G06F 19/12; G06F 19/00

(52) U.S. Cl. CPC G06F 19/12; G06F 19/3437

(57) ABSTRACT

This invention relates generally to (but is not limited to) identifying food compounds that have an impact on a phenotype of interest in a subject, and more particularly to identifying a phenotype-related target, identifying a stimulus (e.g., a pharmaceutical agent) that modulates that target, and identifying food compounds exhibiting similarity to the agent (e.g., having a chemical structure that is similar to the agent's structure). The similarity can be determined, for example, by a computer-interfaced comparison between a drug database and a food database.

### CROSS REFERENCE TO RELATED APPLICATIONS

This application claims the benefit of the filing date of U.S. Provisional Application No. 62/214,510, filed on Sep. 4, 2015, the contents of which are hereby incorporated by reference in their entirety.

### STATEMENT REGARDING FEDERALLY SPONSORED RESEARCH

This invention was made with government support under grant numbers 1950-51000-077-01S and 8050-51000-098-00D, awarded by the Agricultural Research Service of the United States Department of Agriculture, and under grant number 4R21HL114238-03 awarded by the National Heart, Lung, and Blood Institute of the National Institutes of Health. The government has certain rights in the invention.

### FIELD OF THE INVENTION

The invention relates generally to identifying food compounds that have an impact on a phenotype of interest in a subject, and more particularly to identifying a phenotype-related target, identifying a stimulus (e.g., a pharmaceutical agent) that modulates that target, and identifying food compounds exhibiting similarity to the agent (e.g., having a chemical structure that is similar to the agent's structure). The similarity can be determined, for example, by a computer-interfaced comparison between a drug database and a food database.

### SUMMARY OF THE INVENTION

In a first aspect, the present invention features methods of identifying a food compound that has an impact on a phenotype of interest in a subject (e.g., a vertebrate animal). The methods can include steps of: (a) identifying a phenotype-related target; (b) identifying a pharmaceutical agent that modulates the phenotype-related target, thereby generating a pharmaceutical query; (c) submitting the pharmaceutical query via a computer interface to a database of food compounds, thereby identifying a food compound having a specified degree of similarity to the pharmaceutical agent; and (d) subjecting the food compound to a model system to determine whether the compound has an impact on the phenotype of interest. The phenotype of interest can vary widely and can be related to an autoimmune disease, cancer, a cardiovascular disorder, a learning disorder, a metabolic disorder, a neurological disease, a sensory deficit, a skin disorder, a renal insufficiency, a diabetic disease, a muscle disorder, a musculoskeletal disorder, a bone disease, a cardiopulmonary disease, obesity, or a digestive disorder. In other embodiments, the phenotype of interest can be generally related to maintaining health or a healthy appearance. For example, the phenotype can be related to the health of the immune system, prevention of cancer, cardiovascular health, metabolic health, neurological health, good sensory function, skin health, renal health, an ability to regulate blood glucose levels, muscle function, musculoskeletal function, bone health, cardiopulmonary health, a normal body mass index, or digestive health. Where the stimulus is a drug, the drug/pharmaceutical agent can be a chemical compound, a protein, a fatty acid, or a carbohydrate. In assessing similarity, the similarity can be assessed between the overall structure of the pharmaceutical agent and the food compound or between a substituent or substituents therein. In any of the present methods, one can also determine whether the subject has a genotype that would affect an expected influence of the food compound on the phenotype of interest when consumed by the subject. The subject can have a genotype that would decrease the expected influence of the food compound on the phenotype of interest, and the method can further include the step of prescribing a dietary regimen for the subject that increases the subject's consumption of the food compound to a specified level. Conversely, where the subject has a genotype that would amplify the expected influence of the food compound on the phenotype of interest, the method can further include the step of prescribing a dietary regimen for the subject that reduces the subject's consumption of the food compound to a specified level. In other embodiments, where the subject has a genotype that would decrease the expected influence of the food compound on the phenotype of interest, the method can further include identifying an alternative biochemical target; identifying a second food compound that would positively affect the alternative biochemical target; and prescribing a dietary regimen for the subject that increases the subject's consumption of the second food compound to a specified level.

In another aspect, the invention features methods of designing a nutritional food product or supplement. Such methods can include the steps of identifying a food compound that has an impact on a phenotype of interest in a subject (as described further herein) and incorporating the food compound in the nutritional food product in an amount sufficient to affect the phenotype of interest. The nutritional food product can be a cereal or cereal-type bar, a candy or candy bar, a grain product, a meat product, a fish or seafood product, a dairy product, a fruit or vegetable, a preserved food, a juice, water, sauce, dressing, or oil. The nutritional food product can be a whole food, a processed food, a synthetic food, a genetically modified food, or a food chemical or food-derived chemical formulated for oral or parenteral administration.

In another aspect, the invention features methods of setting dietary restrictions for a subject who is being treated with a pharmaceutical agent (e.g., in the context of a clinical trial). Such methods can include the steps of: (a) generating a pharmaceutical query based on the pharmaceutical agent; (b) submitting the pharmaceutical query via a computer interface to a database of food compounds, thereby identifying a food compound having a specified degree of similarity to the pharmaceutical query; and (c) restricting the subject's consumption of the food compound.

In another aspect, the invention features methods of setting dietary restrictions for a subject who is being treated with a pharmaceutical agent (e.g., a subject who is a participant in a clinical trial or a patient for whom the pharmaceutical agent has been prescribed). Such methods can include the steps of: (a) identifying a biological target within the subject that is modulated by the pharmaceutical agent; (b) identifying a second pharmaceutical agent that impacts the modulation of the biological target; (c) generating a pharmaceutical query based on the second pharmaceutical agent; (d) submitting the pharmaceutical query via a computer interface to a database of food compounds, thereby identifying a food compound having a specified degree of similarity to the pharmaceutical query; and (e) restricting the subject's consumption of the food compound. The modulation can be a positive or negative effect, and the impact on the modulation can be a positive or negative effect. The methods can also include a step of subjecting the food compound to a model system to determine whether the compound provides an impact on the modulation of the biological target.

In another aspect, the invention features a computer-readable medium storing software for identifying a food compound and, optionally, the degree of impact of the food compound on a phenotype-related target based on a similarity between the food compound and a pharmaceutical compound of known bioactivity.

As discussed, the methods of the present invention can elucidate connections between specific foods or food compounds, health-relevant phenotypes, and genetic variants. These connections will help to explain why some individuals respond to a particular stimulus (e.g., a component of their diet), and others do not. It remains unknown how most foods and food-based compounds or extracts exert an effect on a biological system (e.g., a human or other vertebrate animal), and the present invention can identify those food-based compounds that are highly similar to certain drugs (e.g., similar in structure or similar by virtue of sharing a chemical, physical, or biological property) or that elicit an effect on a target that mimics the effect of another type of stimulus (as discussed further below). Information pertaining to the mechanism of action of those drugs can then be used to predict and test whether those same mechanisms apply to the food compounds and the foods containing them.

### BRIEF DESCRIPTION OF THE DRAWINGS

FIG. 1 is a diagram illustrating the association between genotype, environment, and phenotype, and the concept of gene-environment interaction affecting phenotype.

FIG. 2 is a diagram illustrating a method according to one aspect of the invention.

FIG. 3 is a diagram illustrating the pharmaceutical agent celastrol and four food compounds (melilotigenin, azukisapogenol, glabric acid, and glycyrrhetic acid) that were identified based on structural similarity to that pharmaceutical agent as described herein.

FIG. 4 is a diagram illustrating the pharmaceutical agent genistein and three food compounds (chrysin, galangin, and pectolinarigenin) that were identified based on structural similarity to that pharmaceutical agent as described herein. As genistein is also found in soy, it can be viewed as a natural product as well as a pharmaceutical agent. As discussed further below, the present methods can be applied to identify foods and food-based compounds that modulate a target in a manner similar to the manner in which the target is modulated by a stimulus. In this case, the stimulus would be a soy-rich diet.

FIG. 5 is a diagram illustrating the potential effect of foods on gene targets based on a list of identified food compounds and phenotype-related gene targets generated using the methods of the invention.

FIG. 6 is a diagram illustrating a computing system 100 that can be used to identify food compounds.

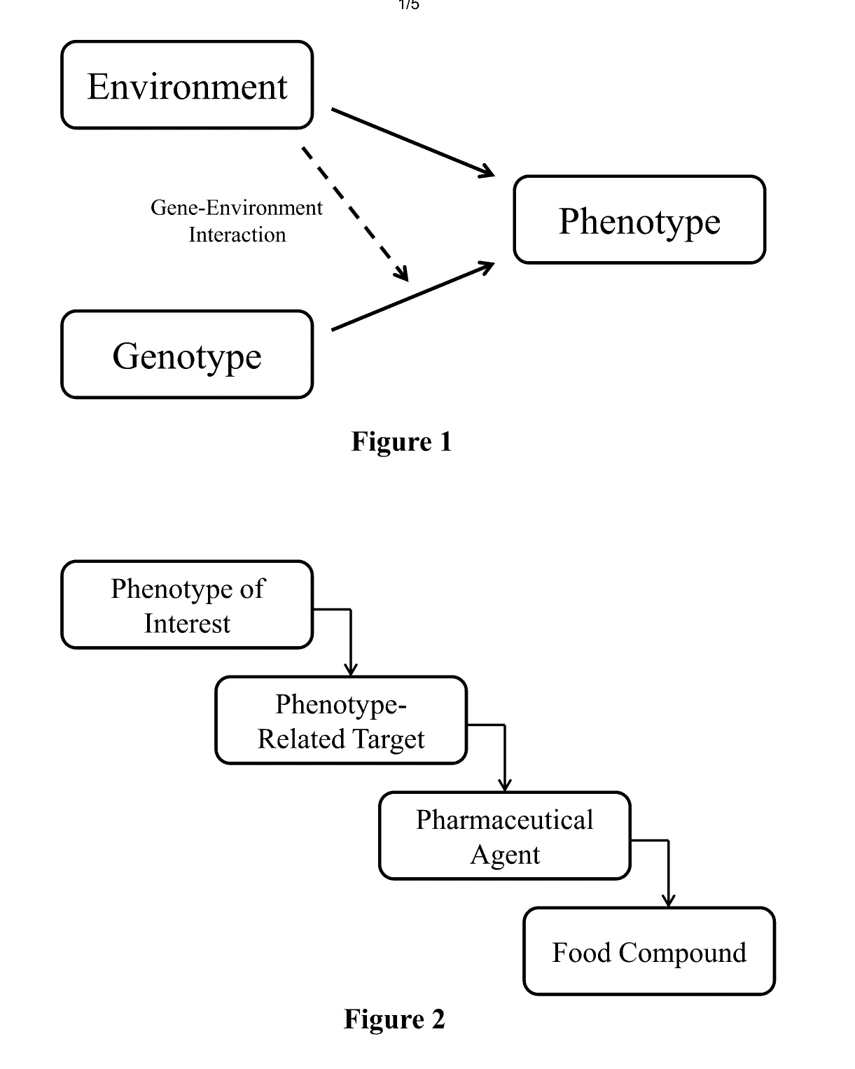

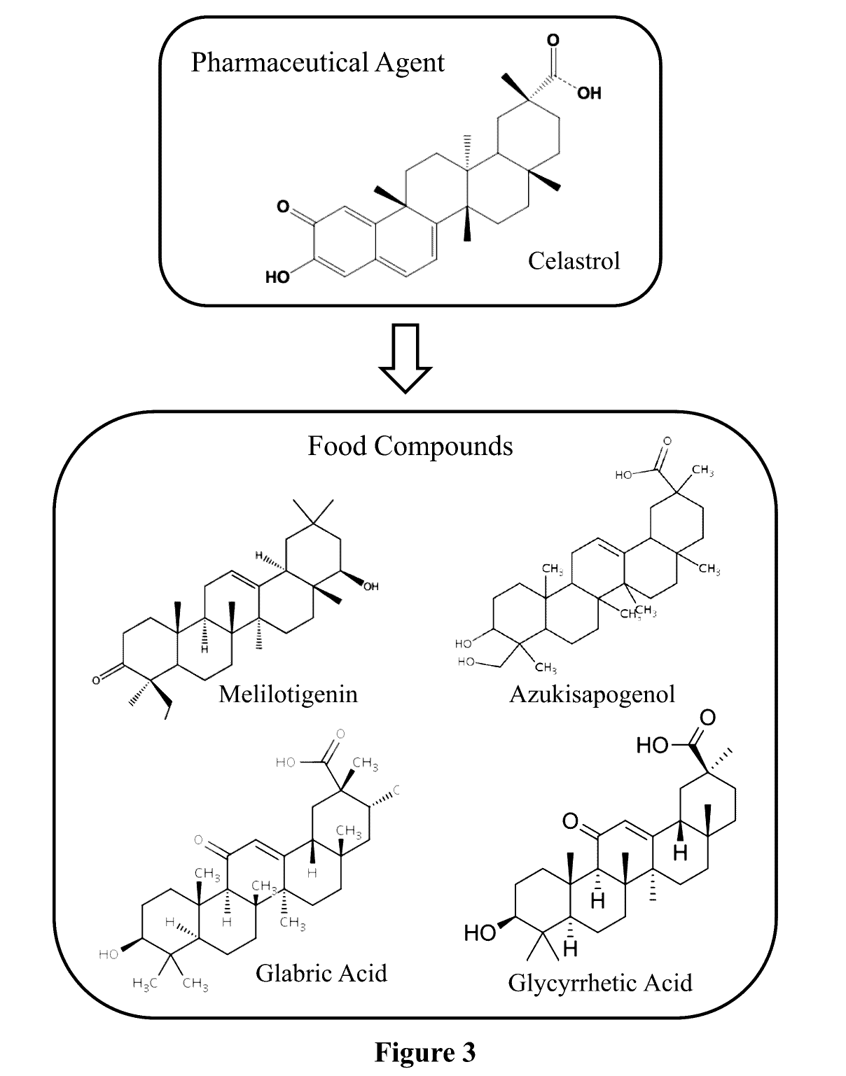

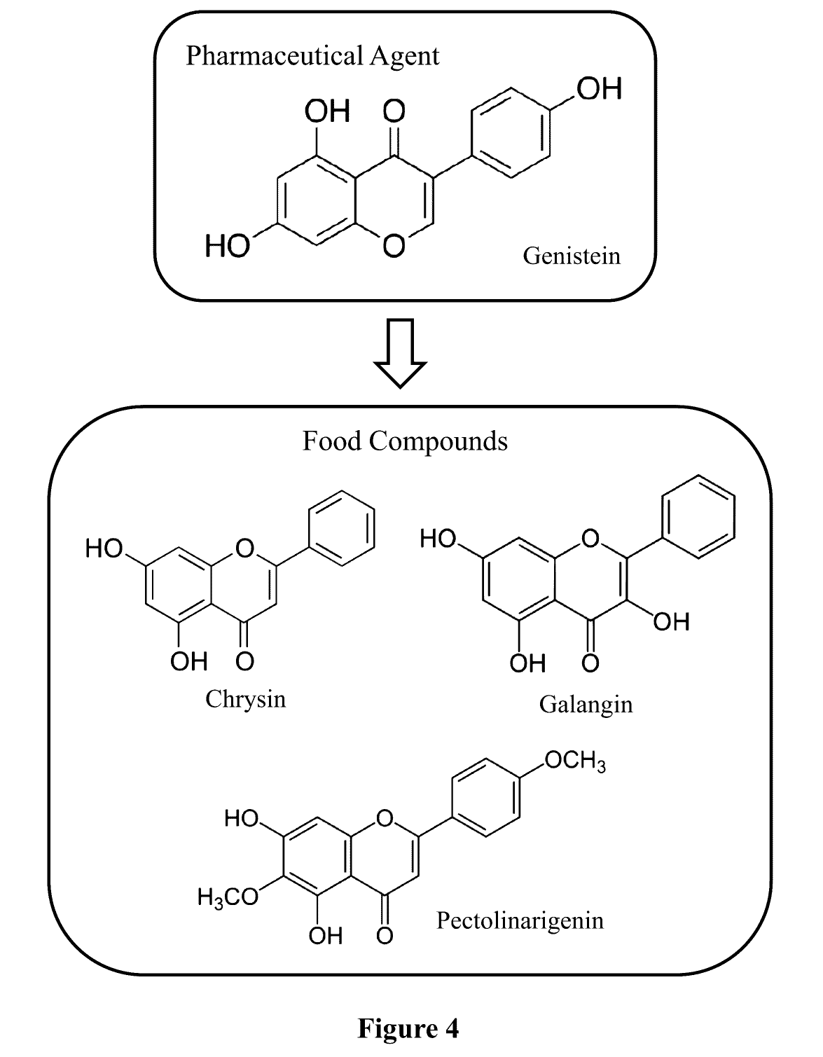

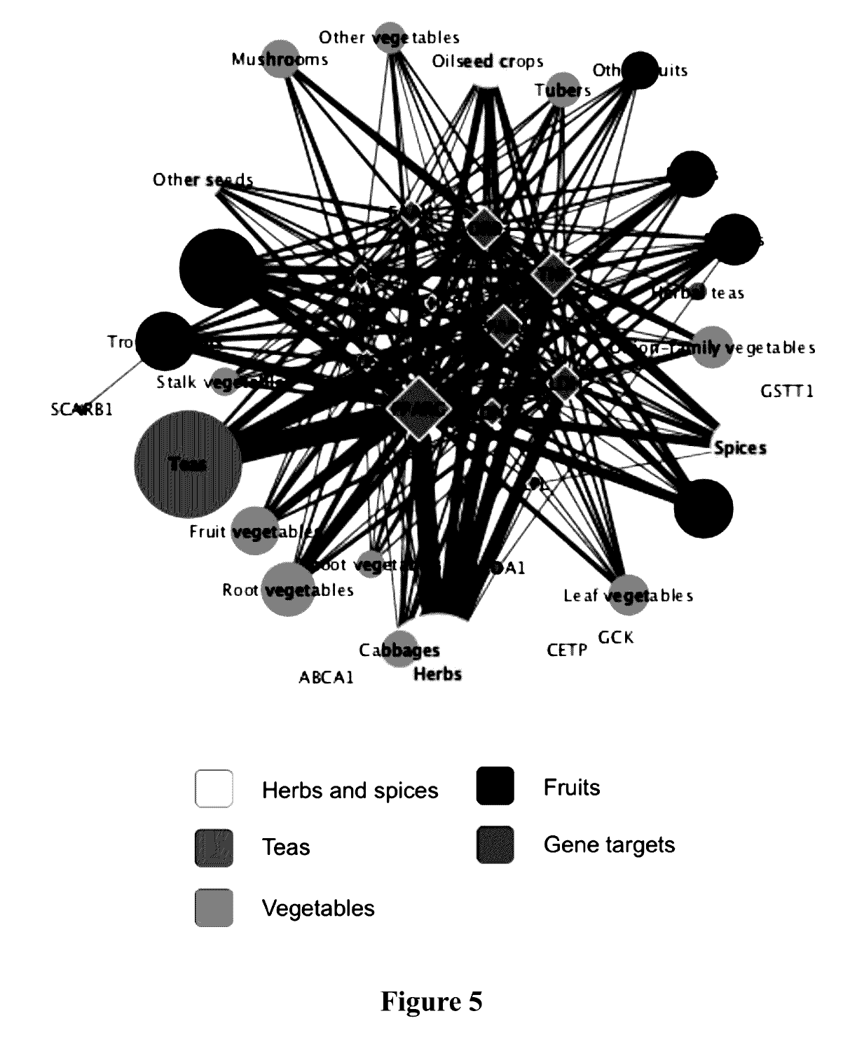

### DETAILED DESCRIPTION

There is a great deal of genetic variation across the human genome. Indirectly, this variation has implications for disease risk, either raising or lowering that risk on a “per allele” basis (but not always in an additive manner). More directly or mechanistically, several lines of evidence show that many alleles have altered activity or transcription rates relative to their wild type counterparts or give rise to proteins with altered functions. This genetic variation is at least partially responsible for differential responses to various stimuli (e.g. exposure to sunlight, response to specific dietary components, and other stimuli as described further below), which can arise from an altered rate of transcription (stemming from allele-specific responses to the stimulus in question) or translation into an altered protein sequence that can affect the conformation of the protein and, thereby, the protein's ability to process or interact with the stimulus, a component thereof, or a downstream effector in the body. Important stimuli include any substance that is consumed, physical activity, sleep, exposure to environmental chemicals, exposure to sunlight, physical manipulation (such as therapeutic touching or massage) and the like.

We and many others have identified stimuli that modulate the association between genotype (genetic variation) and phenotype (a measured characteristic), and these associations are known as gene-environment interactions (GxEs). As a result of genetic variation, two different genotypes can respond to the same stimuli (e.g., the same food/diet or the same environment) in different ways. GxEs contribute significantly to the variance of phenotypes, including disease risk and health maintenance. Although this is generally understood, our ability to identify and subsequently modulate the genes that respond to a given stimulus is still limited. For example, it is still not possible to quickly and reliably identify the genes participating in gene-diet interactions, to identify the food components that mediate desirable interactions and responses, and to bring that information together in order to translate it into a personalized nutrition plan. Individual food compounds and extracts (e.g., plant extracts) can be tested in the laboratory under a variety of conditions and in a number of different cell types in order to characterize the biological responses elicited. However, this approach is often slow and expensive.

Research has also been carried out to discover gene-environment or, more specifically, gene-diet interactions. After surveying a substantial population (e.g., between 1,000 and 100,000 participants) to obtain very detailed dietary intake data, it is possible to ascertain which genetic variants associate with specific cardiometabolic phenotypes (or other phenotypes) as modified by intake of a specific food item, known as a gene-diet interaction, which itself falls under the more general gene-environment interaction. Typically, such gene-diet interactions are described for macronutrients, with specificity concerning the food items rarely reported. However, such gene-diet interaction tests are difficult to conduct because the researcher does not know which phenotype or which food item to focus on, leading to the rise of statistical obstacles in dealing with multiple testing.

In characterizing the effects of food compounds on health, it is possible to mine metabolomics or other similar datasets to identify correlations between levels of a food chemical in samples obtained from subjects (e.g., in blood, stool, or urine samples) and a given disease state or expression of a given phenotype. However, this approach suffers from the lack of focus on a particular chemical or phenotype, as per the discovery of gene-diet interaction described above as well as high costs.

Access to drugs and the use of drugs is generally highly restricted and regulated. Although there are regulations concerning food, these are not nearly as stringent as those that apply to drugs, and access to food is not generally restricted. This may, in part, explain why we have not seen systematic methods for using drugs to identify food compounds that can address insufficiencies, diseases, and clinical issues in the manner that pharmaceutical agents currently are used. Although both pharmaceutical agents and foods are taken with health as the objective, drugs are considered as therapies whereas food is thought of as nutrition and sustenance. This dichotomy in the minds of most individuals, coupled with availability and accessibility issues, has put these items into different classes or categories. Hence, seeking similar biological actions of pharmaceutical agents and food compounds based on shared characteristics (e.g., structural or biological activity) is a solution to the challenge of defining more completely how food makes humans healthy or afflicted with specific diseases (e.g., cardiovascular diseases).

In the field of nutrigenetics, genetics is applied to define an optimal diet for an individual, while nutrigenomics is a field that uses large biological and biomedical datasets to define more accurately the response of an individual and its systems (e.g., the cardiovascular system) to certain dietary and exercise inputs. A goal of both nutrigenomics and nutrigenomics is to understand why the health benefits or health risks of certain diets vary so widely among individuals. That is, the response to nutrition is “personal.” Ultimately, personalized nutrition requires an understanding of how the myriad components of food in our diet(s) interact with an individual's distinct genetic architecture to promote health and prevent disease. Our invention employs a novel approach to identifying diet components that affect specific diseases and/or pathology based on individual genotype. The approach is based on the insight that small molecule drugs have defined gene product (e.g., protein) targets, and the genes for these products have variants (SNPs). There are numerous SNPs per gene, some of which are well characterized and others that are not, leaving the biological impact of many SNPs yet to be determined. Thus, these small molecule drugs link disease states with human genetic variation at specific gene loci. Our computational “matching” of these small molecule drugs (and other types of stimuli) to food components identifies specific food components as modulators of specific disease-associated genes, thereby providing a mechanistic link between individual genotype and health impacts of specific food components.

As described further herein, we have developed methods for identifying foods and food compounds that have an impact on a phenotype of interest in a subject. To practice the methods, one identifies a phenotype-related target and generates a query based on pharmaceutical agents known to modulate the target (e.g., pharmaceutical agents described in various databases or otherwise known in the art). The queries are then submitted via a computer interface to a database of food compounds, thereby identifying one or more food compounds having a specified degree of similarity to the pharmaceutical agent. As described further below, the methods can be performed with any stimulus, not just pharmaceutical compounds.

In some embodiments, the methods described herein can further include determining whether the subject has a genotype that would decrease or amplify the expected influence of the food compound on the phenotype of interest when consumed by the subject. Where the subject has a genotype that would decrease the expected influence of the food compound on the phenotype of interest, the method can further include prescribing a dietary regimen for the subject that increases the subject's consumption of the food compound to a specified level. Conversely, where the subject has a genotype that would amplify the expected influence of the food compound on the phenotype of interest, the method can further include prescribing a dietary regimen for the subject that reduces the subject's consumption of the food compound to a specified level.

In some embodiments, where the subject has a genotype that decreases the expected influence of the food compound on the phenotype of interest, the method can further include identifying an alternative biochemical target; identifying a second food compound that would positively impact the alternative biochemical target; and prescribing a dietary regimen for the subject that increases the subject's consumption of the second food compound to a specified level.

In any of the methods, one can subject the identified food compound to a model system to determine whether (or further test how) the compound affects the phenotype of interest. The model system can be an animal model of disease, a cell culture system, an in vitro system, a mathematical model (e.g., a computational model), or a test carried out with a selected population of subjects (e.g., humans participating in a clinical trial or in an epidemiological model (e.g., with free-living humans as those in the NHANES study)).

In an alternate version of the method, one identifies a phenotype-related target and generates a query based on pharmaceutical agents known to modulate the target. A statistical or “machine learning” model is then trained on this group of queries to identify the structural elements that may contribute to their shared bioactivity. This model is then applied via a computer interface to a database of food compounds in order to either i) classify each compound as having activity against the target or not, or ii) predict the degree of activity of each compound against the target.

As described above, the clinical trial can include new treatments (such as novel vaccines, drugs, dietary choices, dietary supplements, and medical devices) or known interventions. The clinical trial can be a clinical observational study or interventional study. In some embodiments, the clinical trial can be a prevention trial, screening trial, diagnostic trial, treatment trial, quality of life trial, or compassionate use trial. The clinical trial can also be a fixed trial or adaptive clinical trial. In certain embodiments, the clinical trial can be a preclinical trial, phase 0 trial, phase I trial, phase II trial, phase III trial, or phase IV trial.

In another aspect, the invention features methods of designing a nutritional food product or a supplement. To perform these methods, a food, food-based compound, or food extract can be identified by the methods described above and incorporated into the food product or the supplement using known techniques for developing and formulating foods, including through genetic modification.

In another aspect, the invention features methods of setting dietary restrictions for a subject (e.g., a subject participating in a clinical trial of a pharmaceutical agent or a patient who has been prescribed a pharmaceutical agent). These methods can include: identifying a phenotype-related target within the subject that is modulated by the pharmaceutical agent; identifying a second pharmaceutical agent that provides an impact on the modulation of the phenotype-related target; generating a pharmaceutical query based on the second pharmaceutical agent; submitting the pharmaceutical query via a computer interface to a database of food compounds, thereby identifying a food compound having a specified degree of similarity to the pharmaceutical query; and restricting the subject's consumption of the food compound.

In another aspect, the invention features a computer-readable medium storing software for identifying the degree of similarity between a pharmaceutical compound and a database of food compounds.

The phenotype of interest can be related to a disease (e.g., an autoimmune disease, cancer, a cardiovascular disorder, a metabolic disorder, a neurological disease, or a sensory deficit) or can be a desirable trait related to good health or a healthy appearance. Further, the phenotype can be a morphology, developmental progress (e.g., in utero where, for example, fetal intestinal health can be negatively impacted by poor maternal nutrition), a biochemical property, a physiological property, phenology, behavior, product of behavior, or a combination of one or more thereof. In some embodiments, the phenotype can be retention of a mineral (e.g., calcium, which contributes to bone mineral density). The phenotype can also be a body mass index, a healthy level of blood lipids (e.g., total cholesterol, HDL-cholesterol, LDL-cholesterol, triglycerides, Lp(a)), apolipoproteins (APOB and APOA1 especially), or bilirubin. The phenotype can also be a function of key enzymes (e.g., CYP7A1, LIPC, LIPE, LIPG, and CETP). In certain embodiments, the phenotype can be related to a diabetic disease. For example, the phenotype can be a glucose homeostasis or an insulin homeostasis for type 2 diabetes and diabetic complications. The phenotype can also be muscle strength (e.g., grip strength, endurance, max weight for a lift), musculoskeletal joint function, VO2max for lung function, blood pressure, or vascular vessel elasticity. In some embodiments, the phenotype can be related to obesity. The phenotype can also be related to cardiovascular health or cancer, among other afflictions. The phenotype can also be related to cognition, macular degeneration, skin appearance (e.g., the phenotype can be related to elastin, collagen, and the extracellular matrix). The impact that the stimulus and the subsequently identified food or food-based compound has on a phenotype can vary in its character and duration, and can enhance, maintain, or reduce the phenotype.

Although the invention was developed with human subjects in mind, it is not so limited. The present methods can be carried out for the benefit of any vertebrate animal, including a mammal or avian. The subject can also be a domesticated animal (e.g., a dog or cat). The subject can also be an animal kept as livestock (e.g., cattle, sheep, chickens, horses, pigs, or goats). The subject can also be a cell, tissue, organ, organ system, organism, or a medium containing one or more of these.

The phenotype-related target can be any entity within a living body (e.g., a human subject) and can be a small molecule (e.g., a chemical compound), amino acid, peptide, nucleic acid, protein, or any combination thereof. The phenotype-related targets can be naturally existing targets, derived from naturally existing targets, or synthesized targets.

The pharmaceutical agents can be small molecules, amino acids, peptides, nucleic acids, RNAs, DNAs, proteins or a combination of one or more thereof. The pharmaceutical agents can be naturally occurring, derived from naturally existing agents, or synthesized. These features apply to pharmaceutical agents in the role of a “second” agent as described herein (i.e., a pharmaceutical agent that impacts the modulation of the phenotype-related target (by the first pharmaceutical agent)).

The food compounds can also be small molecules, amino acids, peptides, nucleic acids, RNAs, DNAs, proteins or a combination of one or more thereof. The food compounds can also be naturally occurring, derived from naturally existing agents, or synthesized.

In some embodiments, the small molecules can be but not limited to pharmaceutical agents or drugs. For example, the small molecules can be alkaloids, glycosides, lipids, non-ribosomal peptides (e.g., actinomycin-D), phenazines, natural phenols (e.g., flavonoids), polyketides, terpenes (e.g., steroids), tetrapyrroles, or other metabolites.

In some embodiments, the amino acids can be aliphatic amino acids (e.g., glycine, alanine, valine, leucine, isoleucine), hydroxyl or sulfur/selenium-containing amino acids (e.g., serine, cysteine, selenocysteine, threonine, methionine), cyclic amino acids (e.g., proline), aromatic amino acids (e.g., phenylalanine, tyrosine, tryptophan), basic amino acids (e.g., histidine, lysine, arginine), acidic amino acids and their amides (e.g., aspartate, glutamate, asparagine, glutamine).

In other embodiments, the amino acids can be essential amino acids in humans (phenylalanine, valine, threonine, tryptophan, methionine, leucine, isoleucine, lysine, and histidine), conditionally essential amino acids in humans (e.g., arginine, cysteine, glycine, glutamine, proline, tyrosine), or dispensable amino acids in humans (e.g., alanine, aspartic acid, asparagine, glutamic acid, serine).

In some embodiments, the peptides can include isoleucine-proline-proline (IPP), valine-proline-proline (VPP)), ribosomal peptides, nonribosomal peptides, peptones, and peptide fragments. The peptides can also include tachykinin peptides (e.g., substance P, kassinin, neurokinin A, eledoisin, neurokinin B), vasoactive intestinal peptides (e.g., vasoactive intestinal peptide (VIP), pituitary adenylate cyclase activating peptide (PACAP), peptide histidine isoleucine 27 (Peptide PHI 27), growth hormone releasing hormone 1-24 (GHRH 1-24), glucagon, secretin), pancreatic polypeptide-related peptides (e.g., neuropeptide Y (NPY), peptide YY (PYY), avian pancreatic polypeptide (APP), pancreatic polypeptide (PPY)), opioid peptides (e.g., proopiomelanocortin (POMC) peptides, enkephalin pentapeptides, prodynorphin peptides), calcitonin peptides (e.g., calcitonin, amylin, AGG01), and other peptides (e.g., B-type natriuretic peptide (BNP) and lactotripeptides).

In some embodiments, the nucleic acids can be deoxyribonucleic acids (DNAs), ribonucleic acids (RNAs), or artificial nucleic acid analogs. In some embodiments, the DNAs can include a plurality of nucleobases including cytosine (C), guanine (G), adenine (A), thymine (T), other natural nucleobases, or combinations thereof. The nucleobases can also include derivatives of C, G, A, or T, or synthesized nucleobases. In certain embodiments, the DNAs can be in one or more conformations including A-DNA, B-DNA and Z-DNA. The DNAs can also be in linear or branched. In certain embodiments, the DNAs can be single-stranded, double-stranded, or multiple-stranded.

In some embodiments, the RNA can be a messenger RNA (mRNA), transfer RNA (tRNA), ribosomal RNA (rRNA), transfer-messenger RNA (tmRNA), MicroRNA (miRNA), small interfering RNA (siRNA), CRISPR RNA, antisense RNA, pre-mRNA, or small nuclear RNAs (snRNA). The RNAs can also include a plurality of nucleobases including adenine (A), cytosine (C), guanine (G), or uracil (U), other natural nucleobases, or combinations thereof. In certain embodiments, the nucleobases can include derivatives of A, C, G, U, or synthesized nucleobases. The RNAs can also be in linear or branched. In certain embodiments, the RNAs can be single-stranded, double-stranded, or multiple-stranded.

In some embodiments, the artificial nucleic acid analogs can include backbone analogues (e.g., hydrolysis resistant RNA-analogues, precursors to RNA moieties (e.g., TNA, GNA, PNA)) or base analogues (e.g., nucleobase structure analogues, fluorophores, fluorescent base analogues, natural non-canonical bases, base-pairs, metal-base pairs).

In some embodiments, the proteins can be enzymes, blood group antigen proteins, nuclear receptors, transporters, ribosomal proteins, G-protein coupled receptors, voltage-gated ion channels, predicted membrane proteins, predicted secreted proteins, plasma proteins, transcription factors, mitochondrial proteins, RNA polymerase related proteins, RAS pathway related proteins, citric acid cycle related proteins, or cytoskeleton related proteins. The proteins can also be cancer-related genes, candidate cardiovascular disease genes, disease related genes, FDA approved drug targets, or potential drug targets.

As described above, the database of pharmaceutical agents can be drug databases, metabolic pathway databases, compound or compound-specific databases, spectral databases, disease and physiology databases, comprehensive metabolomic databases, or a combination of one or more thereof.

The database of food compounds can be drug databases, metabolic pathway databases, compound or compound-specific databases, spectral databases, disease & physiology databases, comprehensive metabolomic databases, or a combination of one or more thereof

In some embodiments, the drug database can be ChEMBL, DrugBank, DGI: Drug Gene Interaction database, Therapeutic Target DB, PharmGKB, STITCH, or SuperTarget. The drug database can also be a database that provides basic information (e.g., molecular weight, chemical structure, IC50 values, or approval status) of the pharmaceutical agent. Generally, drug databases are accessible via an internet link or via a application program interface (API).

In some embodiments, the metabolic pathway databases can be SMPDB, KEGG, MetaCyc, HumanCyc, BioCyc, EcoCyc, MetaCyc, BioCyc Open Compounds Database (BOCD), WikiPathways, or Reactome.

In some embodiments, the compound or compound-specific databases can be ChEMBL, PubChem, PubChem Substance, PubChem Compound, PubChem BioAssay, Chemical Entities of Biological Interest (ChEBI), ChemSpider, marine natural products database, ACD-Labs chemical databases, the EPA's DSSTox databases, KEGG Glycan, CarbBank, KEGG pathways, or Toxin and Toxin Target Database (T3DB).

In some embodiments, the spectral databases can be Human Metabolome Database (HMDB), BioMagResBank (BMRB), Madison Metabolomics Consortium Database (MMCD), MassBank, Golm Metabolome Database, METLIN Metabolite Database, or Fiehn GC-MS Database.

In some embodiments, the disease & physiology databases can be Online Mendelian Inheritance in Man (OMIM), METAGENE, or On-Line Metabolic and Molecular Basis to Inherited Disease (OMMBID).

In some embodiments, the comprehensive metabolomic databases can be Human Metabolome Database (HMDB), BiGG, or SYSTOMONAS genome Database.

As described above, the computer interface can include application programming interfaces (APIs). In some embodiments, the APIs can include a set of routines, protocols and tools for building software applications. In other embodiments, the APIs can include libraries that include specifications for routines, data structures, object classes, and variables. In other embodiments, the APIs can include libraries that include specifications of remote calls exposed to the API consumers.

In some embodiments, the API specifications can be in forms of International Standard (e.g., POSIX), vendor documentation, (e.g., Microsoft Windows API), the libraries of a programming language (e.g., the Standard Template Library in C++ or the Java APIs), or other forms.

As described above, the query of pharmaceutical agents can contain one or more pharmaceutical agents. In some embodiments, the query is designed to identify a structural similarity. In other embodiments, the query is designed to identify a common chemical property, physical property, or biological property (e.g., the ability to bind a cell-surface receptor or modulate blood glucose levels).

The similarity can be determined by, for example, the Tanimoto score, Jaccard index, Sorensen similarity index, Mountford's index of similarity, Hamming distance, Dice's coefficient, Tversky index, or other statistics (Rogers et al, Science 132: 1115-1118, 1960).

The food product produced in the present methods can be a whole food, genetically modified food, processed food, synthesized food, or a combination of one or more thereof. The food can also be a cereals or cereal-type bars, a candy or candy bar, a grain product, a meat product, a fish or seafood product, a dairy product, a fruit or vegetable, a preserved food, a juice, water, sauce, dressing, or oil. The food can be isolated from natural resources or synthesized.

As described above, the nutritional food product can be a whole food, genetically modified food, processed food, synthesized food, or a combination of one or more thereof. The nutritional food product can also be a cereal or cereal-type bar, a candy or candy bar, a grain product, a meat product, a fish or seafood product, a dairy product, a fruit or vegetable, a preserved food, a juice, water, sauce, dressing, or oil. The nutritional food product can be isolated from natural resources or synthesized.

As described above, the dietary regimen can include whole foods, genetically modified foods, processed foods, synthesized foods, or a combination of one or more thereof. The dietary regimen can also include cereals or cereal-type bars, candies or candy bars, grain products, meat products, fishes or seafood products, dairy products, fruits or vegetables, preserved foods, juices, water, sauces, dressings, or oils. The dietary regimen can include foods or nutritional food products.

In some embodiments, the foods can include breads (e.g., flatbreads, yeasted breads, wheat breads, white breads), dairy products (e.g., milk, butter, ghee, yogurt, cheese, cream and ice cream), fruits (e.g., apples, oranges, bananas, berries and lemons), grains (e.g., potatoes, wheat, rice, oats, barley, bread and pasta), beans (e.g., baked beans, soy beans), meat (e.g., eggs, chicken, fish, turkey, pork, beef), legumes (e.g., alfalfa, clover, peas, beans, lentils, lupins, mesquite, carob, soybeans, peanuts, tamarind), confections (e.g., fats, oils, candies, soft drinks, chocolates), vegetables (e.g., spinach, carrots, onions, peppers, broccoli), edible fungus (fungus including absence of poisonous effects on humans and desirable taste and aroma), or liquids (e.g., waters, teas, fruit juices, vegetable juices, soups, alcohols). In other embodiments, the foods can also include convenience foods that are commercially prepared to optimize ease of consumption, dried foods, or fermented foods prepared by the conversion of carbohydrates to alcohols and carbon dioxide or organic acids using yeasts, bacteria, or a combination thereof.

In some embodiments, the foods can include dietary supplements including but not limited to vitamins (e.g., vitamin A, vitamin B1, vitamin B2, vitamin B3, vitamin B5, vitamin B6, vitamin B7, vitamin B9, vitamin B12, vitamin C, vitamin D, vitamin E, vitamin K, ubiquinone (vitamin Q), flavonoids (vitamin P)), minerals or dietary elements (e.g., calcium, phosphorus, potassium, sulfur, sodium, chlorine, magnesium, iron, cobalt, copper, zinc, manganese, molybdenum, iodine, bromine, selenium), fibers (e.g., arabinoxylans, cellulose, resistant starch, resistant dextrins, inulin, lignin, waxes, chitins, pectins, beta-glucans, and oligosaccharides), unsaturated fatty acids (e.g., myristoleic acids, palmitoleic acids, sapienic acids, oleic acids, elaidic acids, vaccenic acids, linoleic acids, linoelaidic acids, α-linolenic acids, arachidonic acids, eicosapentaenoic acids, erucic acids, docosahexaenoic acids), saturated fatty acids (e.g., caprylic acids, lauric acids, myristic acids, palmitic acids, stearic acids, arachidic acids, behenic acids, lignoceric acids, cerotic acids), amino acids, phytochemicals (e.g., flavonoids, isoflavones, tannins, phenols, polyphenols, stilbenoids, alkaloids, isoprenoids, and terpenoids), or a combination of one or more thereof.

In some embodiments, the amino acids can be aliphatic amino acids (e.g., glycine, alanine, valine, leucine, isoleucine), hydroxyl or sulfur/selenium-containing amino acids (e.g., serine, cysteine, selenocysteine, threonine, methionine), cyclic amino acids (e.g., proline), aromatic amino acids (e.g., phenylalanine, tyrosine, tryptophan), basic amino acids (e.g., histidine, lysine, arginine), acidic amino acids and their amides (e.g., aspartate, glutamate, asparagine, glutamine). The amino acids can be essential amino acids in humans (phenylalanine, valine, threonine, tryptophan, methionine, leucine, isoleucine, lysine, and histidine), conditionally essential amino acids in humans (e.g., arginine, cysteine, glycine, glutamine, proline, tyrosine), or dispensable amino acids in humans (e.g., alanine, aspartic acid, asparagine, glutamic acid, serine).

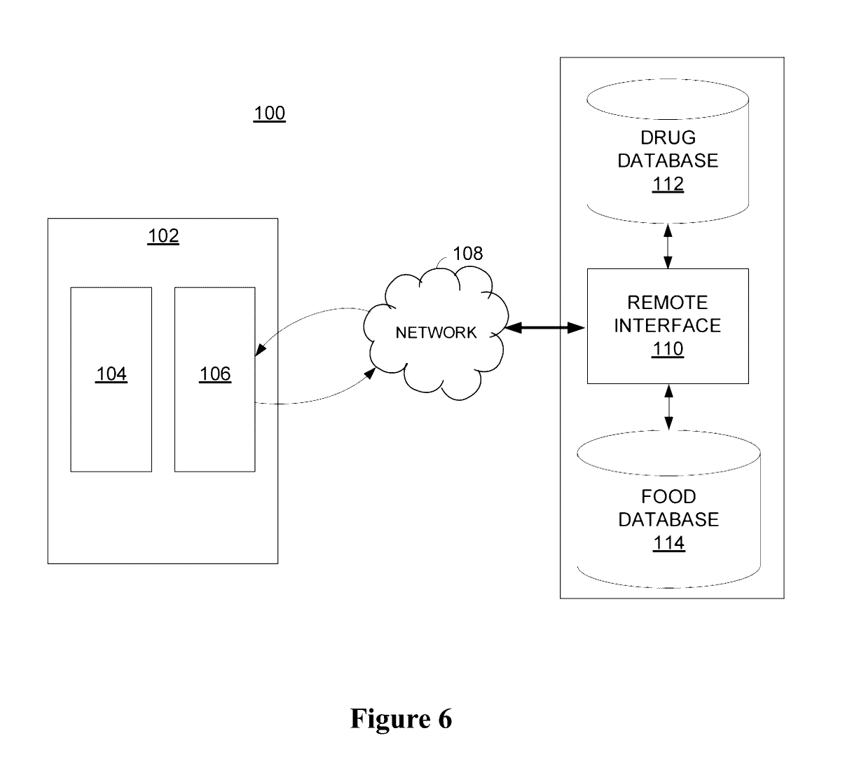

FIG. 6 shows a respect of the invention including a computing system 100 that could be used to perform the queries and the comparison between results of those queries. A computer interface 102 can be implemented, for example, on a computer having one or more processors configured to execute the procedures described herein (e.g., loaded with instructions provided on a computer-readable medium). The computer interface 102 includes a user interface 104 over which a user is able to interact with the system 100. For example, the user interface 104 can be a graphical user interface rendered on a display coupled to the computer interface 102 or provided over a connection between a user's client device and a server on which the computer interface 102 is executing. The computer interface 102 also includes a database interface 106 over which queries can be sent and received over a network 108 to and from a remote interface 110 of one or more database systems that host a drug database 112 and a food database 114. The network 108 may include a local area network (LAN), a wide-area network (WAN), including the Internet, or any combination thereof.

### EXAMPLES

The invention will be further illustrated in the following non-limiting examples.

Using the ChEMBL API, we developed a table linking drugs to food compounds with a stringent Tanimoto chemical similarity of at least 0.85 (T85), which then suggests potentially comparable bioactivity. Additionally, a list of 37 genes supporting published gene-environment (GxE) interactions affecting serum triglycerides was used to generate a list of drugs known to target those encoded proteins. By filtering our T85 food compound-drug dataset to return only these drugs, a resource was created that links food compounds having potential impact on triglycerides to the genes that may mediate this effect, and do so dependent on genotype. Secondarily but with less assurance, novel GxEs are proposed, which involve specific foods and which are more refined than the vast majority of macronutrient-centric GxEs.

The efficacy of this drug-food compound method was verified by exploring specific evidence in the literature in which both the drug and various similar food compounds show experimental effects on triglycerides. Insight into the mechanism of action of these drugs and food compounds was gained through comparison with yeast fitness signatures generated through the analysis of responses to perturbation by small molecules of individual yeast haploinsufficiency lines. With these results, we created a network connecting food groups to the genes upon which they may act. The network highlights the relative importance of each food group as determined by the number of food compounds supporting its proposed effect on triglyceride levels. In principle, this method can be applied to any set of genes to identify potential small molecular effectors arising from specific food chemicals and their food sources.

Resource generation: We retrieved a list of all food compound structures from the FooDB (version 1.0), and we used the list to query the ChEMBL API at chemical similarity (Tanimoto score) cutoffs of both 0.85 and 0.95 to generate a list of all drugs above the similarity cutoff compared to each food compound. We applied Python script using ElementTree to parse the XML output from ChEMBL.

We further verified the reliability of this resource generation. Based on a series of individual queries of SMILES from the final table, we verified that the results in the table for each food compound are congruent with those returned by ChEMBL API. Considering the fact that other sources (Open Babel, ChemMine toolbox) report results with Tanimoto scores <0.85 for pairs that were returned by ChEMBL, we concluded that ChEMBL is a reliable resource to generate our list, especially as the analysis of similarity algorithms is beyond the scope of this project.

Identification of Triglyceride-Level-Related Target: We started by generating a list of 37 GxE genes related to serum triglyceride level from the CardioGxE set as the target. Genes included in the list, such as TNF, and their alleles are previously known to affect the serum triglyceride level.

Identification of Pharmaceutical Agents Based On the Targets: We used the list of genes to search the Drug Gene Interaction Database (DGIdb) and the DrugBank for agents targeting GxE genes that affect TG, and we query the ChEMBL database for agents with: “component_synonym”=gene symbol, followed by cleaning results in R (no agents without names, no repeats). We then identified a list of pharmaceutical agents that are known to target proteins encoded by genes whose variants have a genetic association with TG. These are not TG drugs per se in that these drugs were not designed to target this phenotype. Instead, these drugs, designed for other purposes (ie, phenotypes) target proteins encoded by genes whose variants have a genetic association with TG. The list of agents includes: 256 agents from DrugBank, 531 agents from DGIdb, and 2472 agents from ChEMBL. For example, identified by the process, Celastrol is known to target the TNF gene, and has been shown to lower triglyceride levels in mouse, rat, and rabbit models.

Identification of food compounds based on structural similarity to Pharmaceutical Agents: We generated a filtered master food-agent list for these pharmaceutical agents, returning 13866 “raw” food-agent results. We then merged the master food-agent list and the agent list on string match of agent names (avoids agents without names). Finally, we cleaned the merged list to remove self-hits or highly related compounds, and food compounds with names of “−” to obtain a list of 5099 “clean” results.

In the cleaning process we excluded any self-hit, and any returned hit for any of grep patterns including: Cholic (bile acids), Adenosine, cytidine, guanine, thymidine, uridine, DATP, ADP, Arginine, Cellulose, starch, amylose, lactose, maltose, Cholesterol, Testosterone, estradiol, cortisol, and Coenzyme A. Miscellany About The Data: No palmitic, GLA, n-3, or n-6 fatty acids present.

We retrieved a list of all foods (including food groups and food subgroups) from FooDB, and we cleaned our data by: removing “dishes” and “unclassified” food groups; removing a series of uninformative subgroups including fish products, fruit products, fruits, herb and spice mixtures, herbs and spices, vegetable products, brassicas, green vegetables, pulses, fats and oils, animal foods, beverages, bread products, cereals and cereal products, cocoa and cocoa products, coffee and coffee products, milk and milk products; removing subtypes of all food compounds; and removing any repeated result. As a result, we identified a list of food compounds that are structurally similar to the pharmaceutical agents we have obtained previously. For example, we identified that Azukisapogenol, Melilotigenin, Glabric acid, and Glycyrrhetic acid have similar structures to Celastrol, the agent we have identified. We have also found that Azukisapogenol and Glycyrrhetic acid have been shown experimentally to lower TG levels in the literature.

For another example, using the experimental procedures described above, we have identified the gene PPARG as TG-level-related target, and Genistein as the agent modulating PPARG. We have also identified three food compounds (Chrysin, Galangin, and Pectolinarigenin) that are structural similar to Genistein.

For another example, using the experimental procedures described above, we have identified the gene PPARG as TG-level-related target, and hesperetin (derived from citrus fruits) as the agent modulating PPARG. We have also identified five food compounds (blumeatin, (S)-naringenin, pinocembrin, (S)-pinocembrin, and sakuranetin) that are structurally similar to Hesperetin.

Generation of Food Compound Network: We then generated a bar plot of TG compounds contained by each of the food groups (vegetables, cereals, etc.), and created two related but different network systems:
1. “Richness”: based on the number of unique compound-gene links in a given subgroup
2. “Normalized”: based on the average number of compound-gene links per food in a given subgroup

Networks were generated based on links from subgroups (sources) to genes (targets). We defined node sizes based on the number of compounds per subgroup or gene in both richness and normalized systems. We then scaled down the gene node sizes for “combined” networks with multiple food groups in order to be on the same scale as subgroup node sizes. We further defined edge widths based on “richness” of subgroup-gene link for both systems.

It is to be understood that the foregoing description is intended to illustrate and not to limit the scope of the invention, which is defined by the scope of the appended claims. Other embodiments are within the scope of the following claims.

What is claimed is:

1. A method of identifying a food compound that has an impact on a phenotype of interest in a subject, the method comprising:
(a) identifying a phenotype-related target;
(b) identifying a pharmaceutical agent that modulates the phenotype-related target, thereby generating a pharmaceutical query;
(c) submitting the pharmaceutical query via a computer interface to a database of food compounds, thereby identifying a food compound having a specified degree of similarity to the pharmaceutical agent; and
(d) subjecting the food compound to a model system to determine whether the compound has an impact on the phenotype of interest.

2. The method of claim 1, wherein the subject is a vertebrate animal.

3. The method of claim 1, wherein the phenotype of interest is related to an autoimmune disease, cancer, a cardiovascular disorder, a learning disorder, a metabolic disorder, a neurological disease, a sensory deficit, a skin disorder, a renal insufficiency, a diabetic disease, a muscle disorder, a musculoskeletal disorder, a bone disease, a cardiopulmonary disease, obesity, or a digestive disorder.

4. The method of claim 1, wherein the phenotype of interest is a related to the health of the immune system, prevention of cancer, cardiovascular health, metabolic health, neurological health, good sensory function, skin health, renal health, an ability to regulate blood glucose levels, muscle function, musculoskeletal function, bone health, cardiopulmonary health, a normal body mass index, or digestive health.

5. The method of claim 1, wherein the pharmaceutical agent is a chemical compound, a protein, a fatty acid, or a carbohydrate.

6. The method of claim 1, wherein the similarity is similarity between the overall structure of the pharmaceutical agent and the food compound or between a substituent or substituents therein.

7. The method of claim 1, further comprising determining whether the subject has a genotype that would affect an expected influence of the food compound on the phenotype of interest when consumed by the subject.

8. The method of claim 7, wherein the subject has a genotype that would decrease the expected influence of the food compound on the phenotype of interest and the method further comprises prescribing a dietary regimen for the subject that increases the subject's consumption of the food compound to a specified level.

9. The method of claim 7, wherein the subject has a genotype that would amplify the expected influence of the food compound on the phenotype of interest and the method further comprises prescribing a dietary regimen for the subject that reduces the subject's consumption of the food compound to a specified level.

10. The method of claim 7, wherein the subject has a genotype that would decrease the expected influence of the food compound on the phenotype of interest and the method further comprises identifying an alternative biochemical target; identifying a second food compound that would positively affect the alternative biochemical target; and prescribing a dietary regimen for the subject that increases the subject's consumption of the second food compound to a specified level.

11. A method of designing a nutritional food product or supplement, the method comprising identifying a food compound that has an impact on a phenotype of interest in a subject and incorporating the food compound in the nutritional food product in an amount sufficient to affect the phenotype of interest, wherein identifying the food compound comprises:
(a) identifying a phenotype-related target;
(b) identifying a pharmaceutical agent that modulates the phenotype-related target, thereby generating a pharmaceutical query;
(c) submitting the pharmaceutical query via a computer interface to a database of food compounds, thereby identifying a food compound having a specified degree of similarity to the pharmaceutical query;
(d) subjecting the food compound to a model system to determine whether the compound has an impact on the phenotype of interest; and
(e) selecting the food compound for incorporation in the nutritional food product or supplement.

12. The method of claim 11, wherein the nutritional food product is a cereal or cereal-type bar, a candy or candy bar, a grain product, a meat product, a fish or seafood product, a dairy product, a fruit or vegetable, a preserved food, a juice, water, sauce, dressing, or oil.

13. The method of claim 11, wherein the nutritional food product is a whole food, a processed food, a synthetic food, a genetically modified food, or a food chemical or food-derived chemical formulated for oral or parenteral administration.

14. A method of setting dietary restrictions for a subject who is being treated with a pharmaceutical agent, the method comprising:
(a) generating a pharmaceutical query based on the pharmaceutical agent;
(b) submitting the pharmaceutical query via a computer interface to a database of food compounds, thereby identifying a food compound having a specified degree of similarity to the pharmaceutical query; and
(c) restricting the subject's consumption of the food compound.

15. The method of claim 14, wherein the subject is a participant in a clinical trial or a patient for whom the pharmaceutical agent has been prescribed.

16. A method of setting dietary restrictions for a subject who is being treated with a pharmaceutical agent, the method comprising:
(a) identifying a biological target within the subject that is modulated by the pharmaceutical agent;
(b) identifying a second pharmaceutical agent that impacts the modulation of the biological target;
(c) generating a pharmaceutical query based on the second pharmaceutical agent;
(d) submitting the pharmaceutical query via a computer interface to a database of food compounds, thereby identifying a food compound having a specified degree of similarity to the pharmaceutical query; and
(e) restricting the subject's consumption of the food compound.

17. The method of claim 16, wherein the subject is a participant in a clinical trial or a patient for whom the pharmaceutical agent has been prescribed.

18. The method of claim 16, wherein the modulation is a positive or negative effect.

19. The method of claim 16, wherein the impact on the modulation is a positive or negative effect.

20. The method of claim 16, further comprising a step of subjecting the food compound to a model system to determine whether the compound provides an impact on the modulation of the biological target.

21. A computer-readable medium storing software for identifying a food compound and, optionally, the degree of impact of the food compound on a phenotype-related target based on a similarity between the food compound and a pharmaceutical compound of known bioactivity.
